(19) United States
(12) Patent Application Publication
(10) Pub. No.: US 2026/0110880 A1
(43) Pub. Date: Apr. 23, 2026

(54) IMAGING LENS SYSTEM

(71) Applicant: SAMSUNG ELECTRO-MECHANICS CO., LTD., Suwon-si (KR)

(72) Inventors: Seon Ho RYU, Suwon-si (KR); Hag Chul KIM, Suwon-si (KR); Byung Hyun KIM, Suwon-si (KR)

(73) Assignee: SAMSUNG ELECTRO-MECHANICS CO., LTD., Suwon-si (KR)

(21) Appl. No.: 19/209,987

(22) Filed: May 16, 2025

(30) Foreign Application Priority Data
Oct. 22, 2024 (KR) 10-2024-0145051

(51) Int. Cl. G02B 9/64

(52) U.S. Cl. CPC G02B 9/64

(57) ABSTRACT

An imaging lens system includes a first lens, a second lens, a third lens, a fourth lens, a fifth lens, a sixth lens, a seventh lens, and an eighth lens sequentially disposed from an object side, wherein the first lens includes a reflective surface, and the imaging lens system satisfies 0<f1/f<20, where f is a focal length of the imaging lens system and f1 is a focal length of the first lens.

### CROSS-REFERENCE TO RELATED APPLICATION(S)

This application claims the benefit under 35 USC 119(a) of Korean Patent Application No. 10-2024-0145051 filed on Oct. 22, 2024, in the Korean Intellectual Property Office, the entire disclosure of which is incorporated herein by reference for all purposes.

### 1. FIELD

The present disclosure relates to an imaging lens system configured to capture images of subjects located at infinite and close distances with uniform resolution.

### 2. DESCRIPTION OF THE BACKGROUND

A camera module may be mounted on an electronic device configured to capture a still image or make a recording of a moving image. For example, a camera module can be mounted on a mobile phone, a laptop, a game console, or the like.

The camera module may capture images of subjects at infinite and very close distances by moving one or more lens groups. For example, the camera module may be used to capture subjects located at infinite distances, such as natural landscapes, or subjects located at very close distances, such as documents on a desk. However, camera modules (and imaging lens systems mounted on such camera modules) mounted in limited spaces such as portable terminals have difficulty capturing subjects located at infinite distances and very close distances with the same or uniform resolution due to the size limitations of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens, a second lens, a third lens, a fourth lens, a fifth lens, a sixth lens, a seventh lens, and an eighth lens sequentially disposed from an object side, wherein the first lens includes a reflective surface, and the imaging lens system satisfies 0<f1/f<20, where f is a focal length of the imaging lens system and f1 is a focal length of the first lens.

The first lens may have a convex object-side surface.

The second lens may have a convex object-side surface.

The third lens may have a convex object-side surface.

The fourth lens may have a convex object-side surface.

The fifth lens may have a concave object-side surface.

The sixth lens may have a convex object-side surface.

The seventh lens may have a convex object-side surface.

In another general aspect, an imaging lens system includes a first lens, a second lens, a third lens, a fourth lens, a fifth lens, a sixth lens, a seventh lens having negative refractive power, and an eighth lens having a convex object-side surface sequentially disposed from an object side, wherein the imaging lens system satisfies 5.0<f1/TTL<10.0, where TTL is a distance from an object side of the first lens to an imaging plane and f1 is a focal length of the first lens.

The first lens may have a convex object-side surface. The first lens may be a prism.

The second lens may have a convex object-side surface.

The third lens may have a convex object-side surface.

The fourth lens may have a convex object-side surface.

The fifth lens may have a concave object-side surface.

The sixth lens may have a convex object-side surface.

The seventh lens may have a convex object-side surface.

An electronic device including any of the imaging lens system described herein.

Other features and aspects will be apparent from the following detailed description, the drawings, and the claims.

### BRIEF DESCRIPTION OF DRAWINGS

FIG. 1 is a configuration diagram of an imaging lens system according to a first embodiment of the present disclosure.

FIG. 2 is an aberration curve of the imaging lens system illustrated in FIG. 1.

FIG. 3 is a configuration diagram of an imaging lens system according to a second embodiment of the present disclosure.

FIG. 4 is an aberration curve of the imaging lens system illustrated in FIG. 3.

FIG. 5 is a configuration diagram of an imaging lens system according to a third embodiment of the present disclosure.

FIG. 6 is an aberration curve of the imaging lens system illustrated in FIG. 5.

FIG. 7 is a configuration diagram of an imaging lens system according to a fourth embodiment of the present disclosure.

FIG. 8 is an aberration curve of the imaging lens system illustrated in FIG. 7.

FIG. 9 is an electronic device mounted with an imaging lens system according to an embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In this specification, a first lens refers to a lens closest to an object (or a subject), and a sixth lens or a seventh lens refers to a lens closest to an imaging plane (or an image sensor). In the present specification, units of a radius of curvature, a thickness, TTL (a distance from an object-side surface of the first lens to the imaging plane), an IMGHT (a height of the imaging plane), and a focal length are indicated in millimeters (mm).

A thickness of a lens, a gap between lenses, and a TTL refers to a distance of a lens along an optical axis. Also, in the descriptions of a shape of a lens, a configuration in which one surface is convex indicates that a paraxial region of the surface is convex, and a configuration in which one surface is concave indicates that a paraxial region of the surface may be concave. Thus, even when it is described that one surface of a lens is convex, an edge of the lens may be concave. Similarly, even when it is described that one surface of a lens is concave, an edge of the lens may be convex.

An imaging lens system according to a first aspect of the present disclosure may include a first lens, a second lens, a third lens, a fourth lens, a fifth lens, a sixth lens, a seventh lens, and an eighth lens, sequentially arranged from an object side. The imaging lens system according to the first aspect may include a reflective surface. For example, in the imaging lens system according to the first aspect, the first lens may include a reflective surface. The imaging lens system according to the first aspect may satisfy a unique conditional expression. For example, the imaging lens system according to the first aspect may satisfy the conditional expressions 0<f1/f<20. In the conditional expression, f is a focal length of the imaging lens system, and f1 is a focal length of the first lens.

An imaging lens system according to a second aspect of the present disclosure may include a first lens, a second lens, a third lens, a fourth lens, a fifth lens, a sixth lens, a seventh lens, and an eighth lens, sequentially arranged from an object side. The imaging lens system according to the second aspect may include a plurality of lenses having negative refractive power. For example, in the imaging lens system according to the second aspect, the seventh lens may have negative refractive power. The imaging lens system according to the second aspect may include a lens having a convex surface on one side thereof. For example, in the imaging lens system according to the second aspect, the eighth lens may have a convex object-side surface. The imaging lens system according to the second aspect may satisfy a unique conditional expression. For example, the imaging lens system according to the second aspect may satisfy the conditional expressions 5.0<f1/TTL<10.0. In the conditional expression, TTL is a distance from an object-side surface of the first lens to an imaging plane, and f1 is a focal length of the first lens.

An imaging lens system according to a third aspect of the present disclosure may include a plurality of lens groups. For example, an imaging lens system according to the third aspect may include a first lens group and a second lens group sequentially arranged from an object side. The imaging lens system according to the third aspect may include a lens group drivable in a direction of an optical axis. For example, in the imaging lens system according to the third aspect, the first lens group may be fixed and the second lens group may be configured to be drivable in a direction of an optical axis. The imaging lens system according to the third aspect may include a lens having a convex surface on one side thereof. For example, in the imaging lens system according to the third aspect, the rearmost lens disposed closest to an imaging plane may have a convex object-side surface. The imaging lens system according to the third aspect may satisfy a unique conditional expression. For example, the imaging lens system according to the third aspect may satisfy the conditional expressions 0<f1/f<20. In the conditional expression, f is a focal length of the imaging lens system, and f1 is a focal length of foremost lens disposed closest to an object.

The imaging lens system according to the third aspect may adjust a distance to a subject that may be captured by moving the second lens group. To elaborate, the imaging lens system generally may have a fixed focal length f, expressed by the following Equation 1. However, in the imaging lens system according to the third aspect, the position of the first lens group may be fixed, but the position of the second lens group may move in a direction of an optical axis, so an object and distance that may be captured by the imaging lens system, may be changed. For example, an imaging lens system according to the third aspect may capture a subject at infinite distance with the second lens group disposed closest to the imaging plane, and may capture extremely-close-up subject with the second lens group disposed closest to the first lens group.

$$\frac{1}{f} = \frac{1}{u} + \frac{1}{v} \qquad Equation 1$$

For reference, in Equation 1, u is a distance from a subject to an object side of the foremost lens (a lens disposed closest to the subject), and v is a distance from an image-side surface of the rearmost lens (a lens disposed closest to an imaging plane) to an imaging plane.

An imaging lens system according to a fourth aspect of the present disclosure may include a plurality of lens groups. For example, an imaging lens system according to the fourth aspect may include a first lens group and a second lens group sequentially arranged from an object side. The imaging lens system according to the fourth aspect may include a lens group drivable in a direction of an optical axis. For example, in the imaging lens system according to the fourth aspect, the second lens group may be configured to be drivable in a direction of the optical axis. The imaging lens system according to the fourth aspect may include a lens having a convex surface on one side thereof. For example, in the imaging lens system according to the fourth aspect, the rearmost lens disposed closest to an imaging plane may have a convex object-side surface. The imaging lens system according to the fourth aspect may include a lens having negative refractive power. For example, in the imaging lens system according to the fourth aspect, the lens disposed closest to an object-side surface of the rearmost lens may have negative refractive power. The imaging lens system according to the fourth aspect may satisfy a unique conditional expression. For example, the imaging lens system according to the fourth aspect may satisfy the conditional expression 5.0<f1/TTL<10.0. In the conditional expression, TTL is a distance from an object-side surface to an imaging plane of the foremost lens disposed closest to an object, and f1 is a focal length of a foremost lens.

An imaging lens system according to a fifth aspect of the present disclosure may include a plurality of lens groups. For example, an imaging lens system according to the fifth aspect may include a first lens group and a second lens group sequentially disposed from an object side. The imaging lens system according to the fifth aspect may include a lens group drivable in a direction of an optical axis. For example, in the imaging lens system according to the fifth aspect, the second lens group may be configured to be drivable in a direction of an optical axis. The imaging lens system according to the fifth aspect may include a lens configured to change an optical path. For example, in the imaging lens system according to the fifth aspect, a foremost lens disposed closest to an object may be configured in a prism form. The imaging lens system according to the fifth aspect may include a lens having a convex surface on one side thereof. For example, in the imaging lens system according to the fifth aspect, the foremost lens may have a convex object-side surface.

An imaging lens system according to a sixth aspect of the present disclosure may include a first lens, a second lens, a third lens, a fourth lens, a fifth lens, a sixth lens, a seventh lens, and an eighth lens, sequentially disposed from an object side. The imaging lens system according to the sixth aspect may include a lens configured to change an optical path. For example, in the imaging lens system according to the sixth aspect, the first lens may be configured in a prism form. The imaging lens system according to the sixth aspect may include a lens having a convex surface on one side thereof. For example, in the imaging lens system according to the sixth aspect, the first lens may have a convex object-side surface.

An imaging lens system according to a seventh aspect of the present disclosure may include a first lens group and a second lens group sequentially arranged from an object side. The imaging lens system according to the seventh aspect may include a lens configured to change an optical path. For example, in the imaging lens system according to the seventh aspect, a foremost lens disposed closest to an object may be configured in a prism form. The imaging lens system according to the seventh aspect may satisfy a unique conditional expression. For example, the imaging lens system according to the seventh aspect may satisfy one or more of the following conditional expressions:

$$0 < f 1 / f < 20 ; \qquad ( 1 )$$

$$0.2 < fG 2 / f 8 < 0.5 ; \qquad ( 2 )$$

$$1. 2 < TTL / f < 1.65 ; \qquad ( 3 )$$

$$0.85 < PH / ERmax < 1.2 ; \qquad ( 4 )$$

$$0.2 < EPD / TTL < 0 \text{.45} ; \qquad ( 5 )$$

$$50 < V 2 ; and \qquad ( 6 )$$

$$10 < \vert V 1 - V 2 \vert . \qquad ( 7 )$$

In the above conditional expressions, f is a focal length of an imaging lens system, f1 is a focal length of the foremost lens, f8 is a focal length of the rearmost lens disposed closest to an imaging plane, fG2 is a focal length of the second lens group, TTL is a distance from an object-side surface of the foremost lens to the imaging plane, PH is a height of the foremost lens (or a distance from an object-side surface of the foremost lens to an image-side surface), ERmax is the maximum size of an effective radius of lenses excluding the foremost lens, EPD is a size of an entrance pupil, V1 is an Abbe number of the first lens, and V2 is an Abbe number of the second lens.

In the above conditional expressions, conditional expressions 1 and 4 may be numerical ranges for minimizing a size of an imaging lens system. For example, an imaging lens system satisfying conditions 1 and 4 may minimize a size (effective radius) of lenses disposed on an image side of the foremost lens or may minimize a size of the foremost lens.

In the above conditional expressions, conditional expression 2 may be a numerical range for improving the aberrations of an imaging lens system. For example, an imaging lens system satisfying conditional expression 2 may improve aberrations through the second lens group.

In the above conditional expressions, conditional expression 3 may be a numerical range for maintaining the telephoto characteristics of an imaging lens system. For example, an imaging lens system outside of the numerical range of conditional expression 3 may have difficulty clearly capturing a subject disposed at infinite distance.

In the above conditional expressions, conditional expression 5 may be a numerical range for implementing a bright imaging lens system. For example, an imaging lens system that falls outside of the numerical range of conditional expression 5 may have a high f number, which may have difficulty to capturing subjects disposed at infinite distance.

In the above conditional expressions, conditional expressions 6 and 7 may be numerical ranges for aberration correction. For example, an imaging lens system outside of the numerical ranges of conditional expressions 6 and 7 may have difficulty correcting aberrations through the first and second lenses.

An imaging lens system according to an eighth aspect of the present disclosure may include a first lens, a second lens, a third lens, a fourth lens, a fifth lens, a sixth lens, a seventh lens, and an eighth lens sequentially disposed from an object side, and may satisfy one or more of the following conditional expressions:

$$8. < f 1 / f < 16 ; \qquad ( 1 )$$

$$0.76 < f 2 / f < 1. ; \qquad ( 2 )$$

$$- 1. < f 3 / f < - 0.4 ; \qquad ( 3 )$$

$$0.2 < f 4 / f < 0 \text{.80} ; \qquad ( 4 )$$

$$- 1.2 < f 5 / f < - 0.6 ; \qquad ( 5 )$$

$$1. < f 6 / f < 3. ; \qquad ( 6 )$$

$$- 20 < f 7 / f < - 1. ; and \qquad ( 7 )$$

$$- 2. < f 8 / f < - 1. . \qquad ( 8 )$$

In the above conditional expressions, f is a focal length of an imaging lens system, f1 is a focal length of the foremost lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, and f8 is a focal length of the eighth lens.

The conditional expressions according to the eighth aspect may be a numerical range for limiting refractive power of the first to eighth lenses to optimize the overall length of an imaging lens system. In addition, the conditional expressions according to the eighth aspect may be a numerical range for securing the telephoto characteristics of an imaging lens system. For example, an imaging lens system that does not satisfy the conditional expressions according to the eighth aspect may have an excessively long or short distance from an image-side surface of the first lens to an imaging plane, making it difficult to miniaturize the camera module or capture a subject at infinite distance.

An imaging lens system according to a ninth aspect of the present disclosure may include a first lens, a second lens, a third lens, a fourth lens, a fifth lens, a sixth lens, a seventh lens, and an eighth lens sequentially disposed from an object side, and may satisfy one or more of the following conditional expressions:

$$- 0.9 < ( f 2 + f 3 ) / ( f 4 + f 5 ) < - 0.1 ; \qquad ( 1 )$$

$$- 12 < f 1 / f 8 < - 4. ; and \qquad ( 2 )$$

$$- 12 < f 1 / ( f 3 + f 4 + f 5 ) < - 6. . \qquad ( 3 )$$

The conditional expression according to the ninth aspect may be a numerical range for optimizing the refractive power distribution of the first to fifth lenses and the eighth lens. For example, the first to fifth lenses and the eighth lens that do not satisfy the conditional expression according to the ninth aspect may have difficulty in improving the aberrations of an imaging lens system or in implementing high resolution of an imaging lens system.

An imaging optical system according to a tenth aspect of the present disclosure may include a first lens, a second lens, a third lens, a fourth lens, a fifth lens, a sixth lens, a seventh lens, and an eighth lens sequentially disposed from an object side, and may satisfy one or more of the following conditional expressions:

$$5. < f 1 / TTL < 10 ; \qquad ( 1 )$$

$$2. < f 1 / R 1 < 6. ; \qquad ( 2 )$$

$$0.8 < f 1 / R 2 < 3.2 ; \qquad ( 3 )$$

$$0.6 < f 1 / ( R 1 + R 2 ) < 1.8 ; and \qquad ( 4 )$$

$$20 < f 1 / T 1 < 32. \qquad ( 5 )$$

In the conditional expressions, R1 is a radius of curvature of an object-side surface of the first lens, R2 is a radius of curvature of an image-side surface of the first lens, and T1 is a thickness of the first lens.

The conditional expression according to the tenth aspect may be a numerical range for optimizing refractive power and shape of the first lens. For example, an imaging lens system that does not satisfy the conditional expressions according to the tenth aspect may have refractive power of the first lens too large or too small, making it difficult to miniaturize the imaging lens system or implement the telephoto characteristics of the imaging lens system.

An imaging optical system according to an eleventh aspect of the present disclosure may be configured to include two or more characteristics of the first to tenth aspects. For example, an imaging lens system according to the eleventh aspect may include characteristics of the first aspect and satisfy one or more of the conditional expressions according to the seventh to tenth aspects. For another example, the imaging lens system according to the eleventh aspect may include characteristics of the third aspect while satisfying one or more of the conditional expressions according to the seventh to tenth aspects.

The imaging lens system according to the first to eleventh aspects may include one or more lenses having the following characteristics described below, as desired. For example, the imaging lens system according to the first aspect may include one of the first to eighth lenses according to the following characteristics described below. For another example, the imaging lens system according to the second aspect may include two or more of the first to eighth lenses according to the following characteristics described below. However, the imaging lens system according to the above-described aspect may not necessarily include a lens according to the following characteristics described below. The characteristics of the first to eighth lenses are described below.

The first lens may have refractive power. For example, the first lens may have positive refractive power. The first lens may have a convex shape on one surface. For example, the first lens may have a convex object-side surface. The first lens may have an aspherical shape. For example, the first lens may have an aspherical object-side surface. The first lens may include one or more reflective surfaces. For example, a reflective surface may be formed between an object-side surface and an image-side surface of the first lens. The first lens may be formed of a material having high light transmittance and excellent processability. For example, the first lens may be formed of a glass material. The first lens may have a predetermined refractive index. For example, the first lens may have a refractive index of 1.5 or greater. The first lens may have a predetermined Abbe number. For example, the first lens may have an Abbe number of 60 or greater.

The second lens may have refractive power. For example, the second lens may have positive refractive power. The second lens may have a convex shape on one surface. For example, the second lens may have a convex object-side surface. The second lens may be a spherical surfaces. For example, the second lens may be spherical on both sides. The second lens may be formed of a material having high light transmittance and excellent processability. For example, the second lens may be formed of a glass or a plastic material. The second lens may have a predetermined refractive index. For example, the second lens may have a lower refractive index than the first lens. The second lens may have a predetermined Abbe number. For example, the second lens may have an Abbe number of 90 or greater.

The third lens may have refractive power. For example, the third lens may have negative refractive power. The third lens may have a convex shape on one surface. For example, the third lens may have a convex object-side surface. The third lens may have an aspherical shape. For example, the third lens may be aspherical on both surfaces. The third lens may be formed of a material having high light transmittance and excellent processability. For example, the third lens may be formed of a glass or a plastic material. The third lens may have a predetermined refractive index. For example, the third lens may have a refractive index of 1.6 or greater. The third lens may have a predetermined Abbe number. For example, the third lens may have an Abbe number of 20 to 30.

The fourth lens may have refractive power. For example, the fourth lens may have positive refractive power. The fourth lens may have a convex shape on one surface. For example, the fourth lens may have a convex object-side surface. The fourth lens may have an aspherical shape. For example, the fourth lens may be aspherical on both surfaces. The fourth lens may be formed of a material having high light transmittance and excellent processability. For example, the fourth lens may be formed of a glass or a plastic material. The fourth lens may have a predetermined refractive index. For example, the fourth lens may have a refractive index of 1.5 or greater. The fourth lens may have a predetermined Abbe number. The fourth lens may have an Abbe number of 50 or greater.

The fifth lens may have refractive power. For example, the fifth lens may have negative refractive power. The fifth lens may have a concave shape on one surface. For example, the fifth lens may have a concave object-side surface. The fifth lens may have an aspherical shape. For example, the fifth lens may be aspherical on both surfaces. The fifth lens may be formed of a material having high light transmittance and excellent processability. For example, the fifth lens may be formed of a glass material. The fifth lens may have a predetermined refractive index. For example, the fifth lens may have a refractive index of 1.5 or greater. The fifth lens may have a predetermined Abbe number. The fifth lens may have an Abbe number of 50 or greater.

The sixth lens may have refractive power. For example, the sixth lens may have positive refractive power. The sixth lens may have a convex shape on one surface. For example, the sixth lens may have a convex object-side surface. The sixth lens may have an aspherical shape. For example, the sixth lens may be aspherical on both surfaces. The sixth lens may be formed of a material having high light transmittance and excellent processability. For example, the sixth lens may be formed of a glass or a plastic material. The sixth lens may have a predetermined refractive index. For example, the sixth lens may have a refractive index of 1.6 or greater. The sixth lens may have a predetermined Abbe number. The sixth lens may have an Abbe number less than 24.

The seventh lens may have refractive power. For example, the seventh lens may have negative refractive power. The seventh lens may have a convex shape on one surface. For example, the seventh lens may have a convex object-side surface. The seventh lens may have an aspherical shape. For example, the seventh lens may be aspherical on both surfaces. The seventh lens may be formed of a material having high light transmittance and excellent processability. For example, the seventh lens may be formed of a glass or a plastic material. The seventh lens may have a predetermined refractive index. For example, the seventh lens may have a refractive index of 1.5 or greater. The seventh lens may have a predetermined Abbe number. The seventh lens may have an Abbe number of 30 or greater.

The eighth lens may have refractive power. For example, the eighth lens may have negative refractive power. The eighth lens may have a convex shape on one surface. For example, the eighth lens may have a convex object-side surface. The eighth lens may have an aspherical shape. For example, the eighth lens may be aspherical on both surfaces. The eighth lens may have a shape having an inflection point. For example, an inflection point may be formed on at least one surface of the object-side surface and an image-side surface of the eighth lens. The eighth lens may be formed of a material having high light transmittance and excellent processability. For example, the eighth lens may be formed of a glass or a plastic material. The eighth lens may have a predetermined refractive index. For example, the eighth lens may have a refractive index of 1.5 or greater. The eighth lens may have a predetermined Abbe number. The eighth lens may have an Abbe number of 50 or greater.

An aspherical lens constituting an imaging lens system may be expressed by the following Equation 2.

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad Equation 2$$

In Equation 2, c is the reciprocal of a radius of curvature of a corresponding lens, k is a conic constant, r is a distance from a certain point on an aspherical surface to an optical axis, A, B, C, D, E, F, G, H, and Jare aspherical surface constants, and Z (or SAG) is a height in an optical axis direction from a certain point on the aspherical surface to a vertex of the corresponding aspherical surface.

First to eighth lenses may be separated into a plurality of lens groups. For example, the first to fourth lenses may form a first lens group, and the fifth to eighth lenses may form a second lens group. The first lens group and the second lens group may be configured to have different refractive powers. For example, the first lens group may have positive refractive power, and the second lens group may have negative refractive power. The first lens group and the second lens group according to the present disclosure may satisfy a unique conditional expression. For example, the first lens group and the second lens group may satisfy the conditional expression −1.6<fG1/fG2<−0.80. In the conditional expression, fG1 is a focal length of the first lens group, and fG2 is a focal length of the second lens group.

The imaging lens system may include a stop, an imaging plane, and a filter.

The stop may be disposed between the lenses. The imaging plane may be formed at a point where light refracted by the first lens to the eighth lens converges. The imaging plane may be formed by an image sensor. For example, the imaging plane may be formed on a surface of the image sensor or on an internal side of the image sensor. The filter may be disposed between the eighth lens and the imaging plane. The filter may block certain wavelengths of light. For example, the filter may block light in infrared wavelength.

Hereinafter, embodiments of the present disclosure will be described in detail based on the attached illustrative drawings.

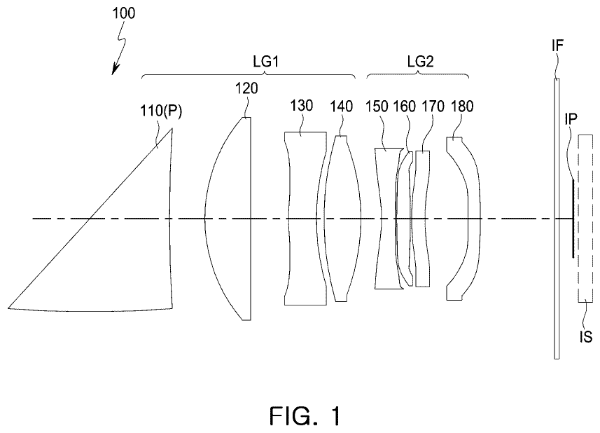

First, an imaging lens system according to a first embodiment will be described with reference to FIG. 1.

An imaging lens system 100 may include a plurality of lens groups. For example, the imaging lens system 100 may include a first lens group LG1 and a second lens group LG2 sequentially arranged from an object side. The first lens group LG1 and the second lens group LG2 may be comprised of a plurality of lenses. For example, the first lens group LG1 may be comprised of a first lens 110, a second lens 120, a third lens 130, and a fourth lens 140. The second lens group LG2 may be comprised of a fifth lens 150, a sixth lens 160, a seventh lens 170, and an eighth lens 180. However, the lenses constituting the first lens group LG1 and the second lens group LG2 may not be limited to the above-described forms.

The imaging lens system 100 may be configured to capture and record subjects at infinite distances and subjects at extremely-close ranges. For example, the imaging lens system 100 may selectively capture and record subjects at infinite and extremely-close distances by adjusting the displacement of the second lens group LG2 that enable to move in an optical axis direction.

The imaging lens system 100 may include a reflective surface. For example, in the imaging lens system 100, the first lens 110 may be configured in a prism form including a reflective surface.

The optical characteristics of the lenses constituting the first lens group LG1 and the second lens group LG2 are described below.

The first lens 110 may have positive refractive power, and may have a convex object-side surface and a concave image-side surface. The second lens 120 may have positive refractive power, and may have a convex object-side surface and a convex image-side surface. The third lens 130 may have negative refractive power, and may have a convex object-side surface and a concave image-side surface. The fourth lens 140 may have positive refractive power, and may have a convex object-side surface and a convex image-side surface. The fifth lens 150 may have negative refractive power, and may have a concave object-side surface and a convex image-side surface. The sixth lens 160 may have positive refractive power, and may have a convex object-side surface and a convex image-side surface. The seventh lens 170 may have negative refractive power, and may have a convex object-side surface and a concave image-side surface. The eighth lens 180 may have negative refractive power, and may have a convex object-side surface and a concave image-side surface.

In the imaging lens system 100, some of the lenses may be configured to have different effective radii in the first direction (X-direction) intersecting an optical axis and in the second direction (Y-direction) intersecting an optical axis. For example, the effective radius of the second lens 120 and the third lens 130 in the second direction may be greater than the effective radius in the first direction. As a specific example, the second lens 120 and the third lens 130 may be lenses having a D-cut shape in which a portion of the lens is cut off.

The imaging lens system 100 may further include a filter IF and an imaging plane IP. The imaging plane IP may be formed on the image sensor IS, and the filter IF may be disposed between the eighth lens 180 and the imaging plane IP.

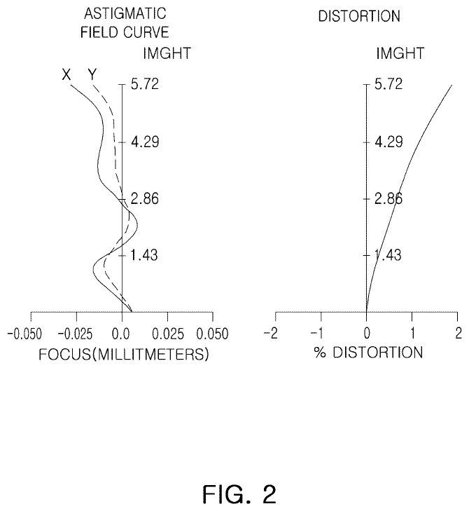

FIG. 2 illustrates an aberration curve of an imaging lens system according to the present disclosure.

Tables 1 to 3 illustrate lens characteristic values, aspherical values, and D1 and D2 values according to the position of the second lens group of the imaging lens system according to the present embodiment.

TABLE 1

| Surface | | Curvature | Thickness/ | Refractive | | Effective | Effective |
|---|---|---|---|---|---|---|---|
| No. | Component | Radius | Distance | Index | Abbe No. | Radius(Y) | Radius(X) |
| S1 | 1st Lens | 89.8550 | 5.0000 | 1.5164 | 64.1100 | 4.70 | 6.00 |
| S2 | Reflective | Infinity | 5.0000 | 1.5164 | 64.1100 | 7.07 | 6.00 |
| | surface | | | | | | |
| S3 | | 282.5549 | 2.0000 | | | 4.65 | 6.00 |
| S4 | 2nd Lens | 8.2108 | 2.8071 | 1.4370 | 95.0990 | 5.12 | 4.20 |
| S5 | | −800.0000 | 2.2615 | | | 4.91 | 4.20 |
| S6 | 3rd Lens | 32.1676 | 1.5778 | 1.6144 | 25.9363 | 4.25 | 4.20 |
| S7 | | 7.0524 | 0.5002 | | | 4.06 | 4.06 |
| S8 | 4th Lens | 11.4633 | 2.2000 | 1.5349 | 55.7354 | 3.83 | 3.83 |
| | (Stop) | | | | | | |
| S9 | | −9.5763 | D1 | | | 4.06 | 4.06 |
| S10 | 5th Lens | −4.4034 | 0.8022 | 1.5349 | 55.7354 | 3.50 | 3.50 |
| S11 | | −8.0715 | 0.1200 | | | 3.35 | 3.35 |
| S12 | 6th Lens | 27.4091 | 0.7498 | 1.6707 | 19.2383 | 3.30 | 3.30 |
| S13 | | −105.2109 | 0.1217 | | | 3.18 | 3.18 |
| S14 | 7th Lens | 8.0313 | 0.7855 | 1.5671 | 37.4035 | 3.18 | 3.18 |
| S15 | | 5.4366 | 2.5685 | | | 3.30 | 3.30 |
| S16 | 8th Lens | 39.1852 | 0.7093 | 1.5349 | 55.7354 | 3.61 | 3.61 |
| S17 | | 12.1556 | D2 | | | 4.00 | 4.00 |
| S18 | Filter | Infinity | 0.2100 | 1.5168 | 64.20 | 7.00 | 7.00 |
| S19 | | Infinity | 0.8815 | | | 7.00 | 7.00 |
| S20 | Imaging | Infinity | 0.0050 | | | | |
| | plane | | | | | | |

TABLE 2

| Surface | | | | | | | | |
|---|---|---|---|---|---|---|---|---|
| No. | S1 | S3 | S4 | S5 | S6 | S7 | S8 | S9 |
| K | −5.29E+01 | 0 | 0 | 0 | −3.64E+00 | −9.75E+00 | 4.33E−01 | 1.11E+00 |
| A | −2.02E−06 | 0 | 0 | 0 | 5.15E−01 | −2.02E−03 | 1.68E−01 | −1.69E−01 |
| B | 1.49E−09 | 0 | 0 | 0 | −2.54E−02 | 4.96E−04 | −5.71E−04 | −2.60E−02 |
| C | −3.81E−10 | 0 | 0 | 0 | −7.77E−04 | −5.29E−05 | −1.67E−02 | −7.40E−03 |
| D | −8.50E−13 | 0 | 0 | 0 | 7.84E−04 | 5.01E−06 | 2.42E−03 | −4.16E−04 |
| E | 0.00E+00 | 0 | 0 | 0 | −1.27E−04 | −4.26E−07 | 7.02E−04 | 6.64E−05 |
| F | 0.00E+00 | 0 | 0 | 0 | 5.33E−05 | 2.60E−08 | 3.63E−05 | 7.18E−05 |
| G | 0.00E+00 | 0 | 0 | 0 | 6.75E−06 | −1.04E−09 | −1.34E−05 | 4.92E−05 |
| H | 0.00E+00 | 0 | 0 | 0 | 6.22E−06 | 2.51E−11 | 2.20E−05 | 1.70E−05 |
| J | 0.00E+00 | 0 | 0 | 0 | 1.36E−05 | −2.78E−13 | 6.63E−07 | 3.09E−06 |
| L | 0.00E+00 | 0 | 0 | 0 | 6.95E−06 | 0.00E+00 | −2.27E−06 | −1.61E−06 |
| M | 0.00E+00 | 0 | 0 | 0 | 8.57E−06 | 0.00E+00 | 9.52E−07 | 2.45E−06 |
| N | 0.00E+00 | 0 | 0 | 0 | 3.82E−06 | 0.00E+00 | −4.83E−07 | 1.32E−07 |
| O | 0.00E+00 | 0 | 0 | 0 | 3.56E−06 | 0.00E+00 | 3.63E−07 | 3.11E−07 |
| P | 0.00E+00 | 0 | 0 | 0 | 1.67E−06 | 0.00E+00 | 2.92E−08 | −3.07E−07 |

| Surface | | | | | | | | |
|---|---|---|---|---|---|---|---|---|
| No. | S10 | S11 | S12 | S13 | S14 | S15 | S16 | S17 |
| K | −9.14E+00 | 1.03E−09 | 3.70E+00 | −3.65E−12 | 1.34E−09 | −1.15E+01 | −7.93E+01 | 2.65E+00 |
| A | −5.55E−01 | −1.25E+00 | −2.06E−01 | −1.54E−01 | 3.64E−01 | 2.52E−01 | 1.46E+00 | 1.81E+00 |
| B | 1.42E−01 | 2.93E−01 | −7.87E−02 | −1.01E−01 | 7.06E−02 | 3.78E−02 | −1.47E−01 | −1.81E−01 |
| C | −3.59E−02 | −5.19E−02 | 4.80E−03 | −4.02E−06 | −1.76E−02 | −2.85E−02 | −1.48E−02 | 1.71E−02 |
| D | 1.13E−02 | 1.82E−02 | −8.81E−04 | −4.62E−03 | 6.17E−03 | 3.63E−03 | −7.85E−03 | −5.97E−03 |
| E | −3.80E−03 | −5.20E−03 | 4.39E−03 | 7.12E−03 | 1.82E−03 | −2.48E−03 | 4.31E−04 | 1.07E−03 |
| F | 1.55E−03 | −3.60E−04 | −3.18E−03 | −2.06E−03 | −3.10E−04 | 4.47E−04 | 3.25E−04 | −6.37E−05 |
| G | −3.88E−04 | 2.27E−04 | 3.71E−04 | 6.19E−04 | 3.08E−04 | −4.65E−04 | 1.20E−04 | −1.58E−05 |
| H | 1.53E−04 | 2.81E−04 | −1.33E−04 | −4.60E−04 | −1.13E−04 | 1.34E−04 | −1.13E−04 | −4.55E−05 |
| J | −3.16E−05 | 5.40E−04 | 6.34E−04 | 2.04E−04 | −1.04E−05 | −1.19E−04 | 1.64E−05 | −1.33E−06 |
| L | −1.80E−05 | −4.86E−04 | −2.84E−04 | 4.21E−05 | 5.77E−05 | 4.84E−05 | −3.75E−05 | −9.53E−06 |
| M | 2.23E−05 | 1.06E−04 | 5.37E−05 | −2.36E−05 | −6.10E−05 | −3.43E−05 | 2.57E−05 | 9.48E−06 |
| N | −1.74E−05 | −5.33E−05 | −1.27E−05 | 5.91E−05 | 4.54E−05 | 1.37E−05 | −2.45E−05 | −1.77E−05 |
| O | 1.02E−05 | 4.22E−05 | 4.88E−06 | −1.83E−05 | −9.00E−06 | −3.50E−06 | 1.16E−05 | 8.24E−06 |
| P | −2.55E−06 | −9.11E−06 | −1.03E−06 | −1.18E−06 | −3.20E−06 | −5.37E−06 | −9.01E−07 | −2.23E−06 |

TABLE 3

| | Telephoto | wide |
|---|---|---|
| D1 | 1.200 | 3.674 |
| D2 | 4.500 | 2.026 |

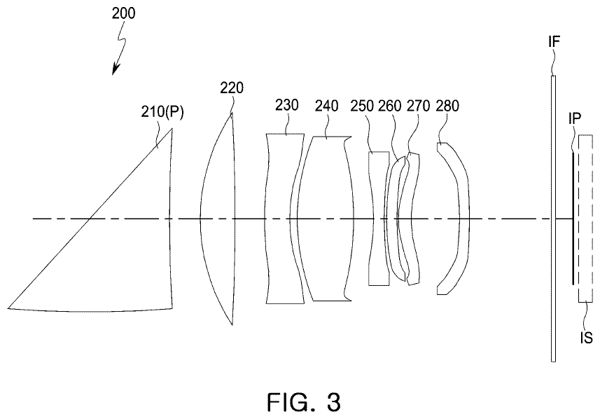

An imaging lens system according to a second embodiment will be described with reference to FIG. 3.

An imaging lens system 200 may include a plurality of lens groups. For example, the imaging lens system 200 may include a first lens group LG1 and a second lens group LG2 sequentially disposed from an object side. The first lens group LG1 and the second lens group LG2 may be comprised of a plurality of lenses. For example, the first lens group LG1 may be comprised of a first lens 210, a second lens 220, a third lens 230, and a fourth lens 240. The second lens group LG2 may be comprised of a fifth lens 250, a sixth lens 260, a seventh lens 270, and an eighth lens 280. However, the lenses configuring the first lens group LG1 and the second lens group LG2 may not be limited to the above-described forms.

The imaging lens system 200 may be configured to capture and record a subject at infinite extremely-close range distances. For example, the imaging lens system 200 may selectively capture and record subjects at infinite and ultra-close range distances by adjusting a displacement of the second lens group LG2 that enables it to move in an optical axis direction. The imaging lens system 200 may include a reflective surface. For example, in the imaging lens system 200, the first lens 210 may be configured in a prism form including a reflective surface.

The optical characteristics of the lenses constituting the first lens group LG1 and the second lens group LG2 are described below.

The first lens 210 may have positive refractive power, and may have a convex object-side surface and a concave image-side surface. The second lens 220 may have positive refractive power, and may have a convex object-side surface and a convex image-side surface. The third lens 230 may have negative refractive power, and may have a convex object-side surface and a concave image-side surface. The fourth lens 240 may have positive refractive power, and may have a convex object-side surface and a convex image-side surface. The fifth lens 250 may have negative refractive power, and may have a concave object-side surface and a convex image-side surface. The sixth lens 260 may have positive refractive power, and may have a convex object-side surface and a concave image-side surface. The seventh lens 270 may have negative refractive power, and may have a convex object-side surface and a concave image-side surface. The eighth lens 280 may have negative refractive power, and may have a convex object-side surface and a concave image-side surface.

In the imaging lens system 200, some lenses may be configured to have different effective radii in the first direction (X-direction) intersecting an optical axis and in the second direction (Y-direction) intersecting an optical axis. For example, the effective radius of the second lens 220 and the fourth lens 240 in the second direction may be larger than the effective radius in the first direction. As a specific example, the second lens 220 to the fourth lens 240 may be lenses having a D-cut shape in which a portion of the lens is cut off.

The imaging lens system 200 further includes a filter IF and an imaging plane IP. The imaging plane IP may be formed on the image sensor IS, and the filter IF may be disposed between the eighth lens 280 and the imaging plane IP.

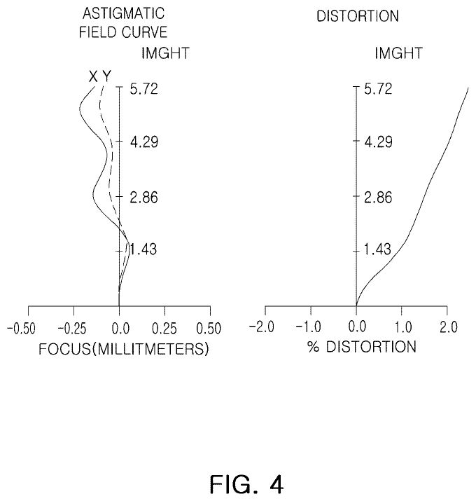

FIG. 4 illustrates an aberration curve of an imaging lens system according to the present disclosure.

Tables 4 to 6 illustrate lens characteristic values, aspherical values, and D1 and D2 values according to the position of the second lens group of the imaging lens system according to the present embodiment.

TABLE 4

| Surface | | Curvature | Thickness/ | Refractive | | Effective | Effective |
|---|---|---|---|---|---|---|---|
| No. | Component | Radius | Distance | Index | Abbe No. | Radius(Y) | Radius(X) |
| S1 | 1st Lens | 71.1537 | 4.8000 | 1.5164 | 64.1100 | 4.40 | 6.00 |
| S2 | Reflective | Infinity | 4.6000 | 1.5164 | 64.1100 | 6.50 | 6.00 |
| | surface | | | | | | |
| S3 | | 217.0867 | 2.0000 | | | 4.40 | 6.00 |
| S4 | 2nd Lens | 10.1857 | 2.1153 | 1.4370 | 95.0990 | 5.24 | 4.20 |
| S5 | | −82.0759 | 1.6974 | | | 5.15 | 4.20 |
| S6 | 3rd Lens | 12.4828 | 1.4254 | 1.6144 | 25.9363 | 4.56 | 4.20 |
| S7 | | 5.2524 | 0.4438 | | | 4.37 | 4.20 |
| S8 | 4th Lens | 9.7215 | 3.3637 | 1.5349 | 55.7354 | 4.35 | 4.20 |
| | (Stop) | | | | | | |
| S9 | | −10.6069 | D1 | | | 3.91 | 3.91 |
| S10 | 5th Lens | −4.3289 | 0.6655 | 1.5349 | 55.7354 | 3.23 | 3.23 |
| S11 | | −8.9861 | 0.1000 | | | 3.17 | 3.17 |
| S12 | 6th Lens | 14.0571 | 0.6827 | 1.6707 | 19.2383 | 3.18 | 3.18 |
| S13 | | 22.1782 | 0.1337 | | | 3.06 | 3.06 |
| S14 | 7th Lens | 6.0476 | 0.7094 | 1.6144 | 25.9363 | 3.09 | 3.09 |
| S15 | | 5.6252 | 2.8181 | | | 3.24 | 3.24 |
| S16 | 8th Lens | 58.5549 | 0.5000 | 1.5349 | 55.7354 | 3.56 | 3.56 |
| S17 | | 13.6958 | D2 | | | 3.89 | 3.89 |
| S18 | Filter | Infinity | 0.2100 | 1.5168 | 64.20 | 7.00 | 7.00 |
| S19 | | Infinity | 0.9350 | | | 7.00 | 7.00 |
| S20 | Imaging | Infinity | 0.0011 | | | | |
| | plane | | | | | | |

TABLE 5

| Surface | | | | | | | | |
|---|---|---|---|---|---|---|---|---|
| No. | S1 | S3 | S4 | S5 | S6 | S7 | S8 | S9 |
| K | −6.51E+00 | 0 | 0 | 0 | −9.91E+00 | −7.27E+00 | 4.41E−01 | 2.02E−01 |
| A | −5.33E+00 | 0 | 0 | 0 | 6.71E−01 | −2.00E−03 | 1.89E−01 | −1.54E−01 |
| B | −6.20E+00 | 0 | 0 | 0 | −2.72E−02 | 4.99E−04 | −6.49E−02 | −2.64E−02 |
| C | −6.34E+00 | 0 | 0 | 0 | 1.80E−03 | −5.28E−05 | −1.50E−02 | −5.56E−03 |
| D | −5.82E+00 | 0 | 0 | 0 | −4.69E−04 | 5.02E−06 | 4.15E−03 | 1.87E−04 |
| E | −4.84E+00 | 0 | 0 | 0 | 4.48E−05 | −4.26E−07 | 4.34E−04 | −5.88E−04 |
| F | −3.66E+00 | 0 | 0 | 0 | −1.22E−04 | 2.60E−08 | −3.12E−04 | 3.01E−04 |
| G | −2.52E+00 | 0 | 0 | 0 | 6.25E−05 | −1.04E−09 | −2.53E−04 | −1.84E−04 |
| H | −1.57E+00 | 0 | 0 | 0 | −5.01E−05 | 2.50E−11 | 4.70E−05 | 1.01E−04 |
| J | −8.74E−01 | 0 | 0 | 0 | 2.19E−05 | −2.78E−13 | −5.57E−05 | −6.82E−05 |
| L | −4.30E−01 | 0 | 0 | 0 | −1.55E−05 | 0.00E+00 | 2.96E−05 | 6.05E−05 |
| M | −1.81E−01 | 0 | 0 | 0 | 1.29E−05 | 0.00E+00 | −3.72E−05 | −2.35E−05 |
| N | −6.30E−02 | 0 | 0 | 0 | −1.49E−05 | 0.00E+00 | 3.79E−05 | 4.75E−06 |
| O | −1.64E−02 | 0 | 0 | 0 | 6.96E−07 | 0.00E+00 | −4.14E−05 | −6.16E−06 |
| P | −2.67E−03 | 0 | 0 | 0 | 1.95E−06 | 0.00E+00 | 2.87E−05 | 4.86E−07 |

| Surface | | | | | | | | |
|---|---|---|---|---|---|---|---|---|
| No. | S10 | S11 | S12 | S13 | S14 | S15 | S16 | S17 |
| K | −1.14E+01 | −2.30E−01 | 2.65E+00 | 7.15E−01 | −1.03E−01 | −6.01E+00 | 9.90E+01 | 3.98E+00 |
| A | −4.97E−01 | −1.13E+00 | −1.43E−01 | −1.36E−01 | 2.75E−01 | 1.85E−01 | 1.40E+00 | 1.73E+00 |
| B | 1.11E−01 | 2.30E−01 | −6.71E−02 | −7.60E−02 | 6.99E−02 | 5.35E−02 | −1.05E−01 | −1.38E−01 |
| C | −2.42E−02 | −4.01E−02 | −5.37E−03 | −1.66E−02 | −7.42E−03 | −3.02E−03 | −5.88E−04 | 1.76E−02 |
| D | 6.62E−03 | 1.27E−02 | 1.63E−03 | 4.66E−04 | 7.13E−03 | 1.08E−03 | −1.33E−02 | −1.20E−02 |
| E | −2.49E−03 | −2.47E−03 | 4.27E−03 | 6.58E−03 | 4.38E−03 | −1.61E−04 | −3.74E−03 | −2.23E−03 |
| F | 1.19E−03 | 2.75E−04 | −3.15E−03 | −4.86E−03 | −3.27E−03 | −1.14E−03 | −1.10E−03 | −1.11E−03 |
| G | −4.20E−04 | 1.04E−03 | 2.83E−03 | 4.08E−03 | 3.13E−03 | 9.19E−05 | −4.79E−05 | −4.02E−04 |
| H | 1.83E−04 | −1.67E−03 | −2.90E−03 | −3.30E−03 | −2.36E−03 | −3.13E−04 | 2.89E−04 | 1.28E−04 |
| J | −1.28E−04 | 5.74E−04 | 9.14E−04 | 1.15E−03 | 1.16E−03 | 1.21E−04 | 5.56E−05 | −9.25E−05 |
| L | 3.48E−05 | −3.20E−04 | −6.41E−04 | −9.88E−04 | −7.96E−04 | −2.40E−05 | 7.19E−05 | 1.01E−04 |
| M | −2.73E−05 | 2.79E−04 | 3.28E−04 | 1.79E−04 | 2.05E−04 | 3.68E−05 | −1.48E−05 | −5.19E−05 |
| N | 4.11E−05 | 1.03E−04 | 1.13E−04 | 5.57E−05 | −4.07E−05 | 2.93E−05 | 1.60E−05 | 5.41E−05 |
| O | −3.36E−05 | −1.66E−04 | −1.54E−04 | −1.88E−05 | −9.24E−06 | −3.51E−05 | 6.79E−06 | 2.67E−06 |
| P | 1.18E−05 | 2.50E−05 | 4.23E−06 | 1.03E−05 | −1.11E−05 | 1.25E−05 | −9.53E−06 | 2.05E−05 |

TABLE 6

| | Telephoto | wide |
|---|---|---|
| D1 | 1.200 | 3.575 |
| D2 | 5.000 | 2.625 |

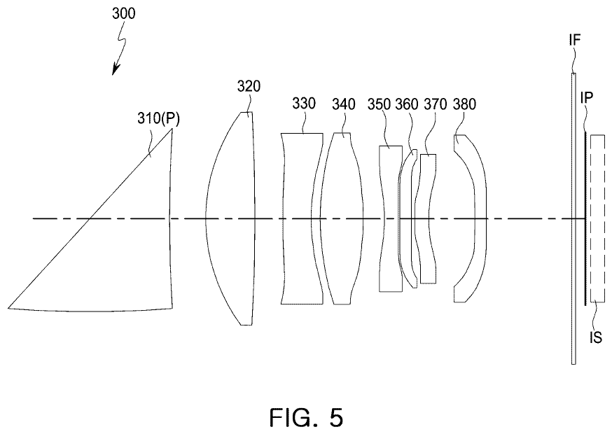

An imaging lens system according to a third embodiment will be described with reference to FIG. 5.

The imaging lens system 300 may include a plurality of lens groups. For example, the imaging lens system 300 may include a first lens group LG1 and a second lens group LG2 sequentially disposed from an object side. The first lens group LG1 and the second lens group LG2 may be comprised of a plurality of lenses. For example, the first lens group LG1 may be comprised of a first lens 310, a second lens 320, a third lens 330, and a fourth lens 340. The second lens group LG2 may be comprised of a fifth lens 350, a sixth lens 360, a seventh lens 370, and an eighth lens 380. However, the lenses configuring the first lens group LG1 and the second lens group LG2 may not be limited to the above-described forms.

The imaging lens system 300 may be configured to capture and record a subject at infinite and extremely-close range distances. For example, the imaging lens system 300 may selectively capture and record subjects at infinite and extremely-close range distances by adjusting a displacement of the second lens group LG2 that enable to move in an optical axis direction. The imaging lens system 300 may include a reflective surface. For example, in the imaging lens system 300, the first lens 310 may be configured in a prism form including a reflective surface.

The optical characteristics of the lenses configuring the first lens group LG1 and the second lens group LG2 are described below.

The first lens 310 may have positive refractive power, and may have a convex object-side surface and a concave image-side surface. The second lens 320 may have positive refractive power, and may have a convex object-side surface and a convex image-side surface. The third lens 330 may have negative refractive power, and may have a convex object-side surface and a concave image-side surface. The fourth lens 340 may have positive refractive power, and may have a convex object-side surface and a convex image-side surface. The fifth lens 350 may have negative refractive power, and may have a concave object-side surface and a convex image-side surface. The sixth lens 360 may have positive refractive power, and may have a convex object-side surface and a concave image-side surface. The seventh lens 370 may have negative refractive power, and may have a convex object-side surface and a concave image-side surface. The eighth lens 380 may have negative refractive power, and may have a convex object-side surface and a concave image-side surface.

In the imaging lens system 300, some of lenses may be configured to have different effective radii in the first direction (X-direction) intersecting an optical axis and in the second direction (Y-direction) intersecting an optical axis. For example, the effective radius of the second lens 320 and the third lens 330 in the second direction may be greater than the effective radius in the first direction. As a specific example, the second lens 320 and the third lens 330 may be lenses having a D-cut shape in which a portion of the lens is cut off.

The imaging lens system 300 may further include a filter IF and an imaging plane IP. The imaging plane IP may be formed on the image sensor IS, and the filter IF may be disposed between the eighth lens 380 and the imaging plane IP.

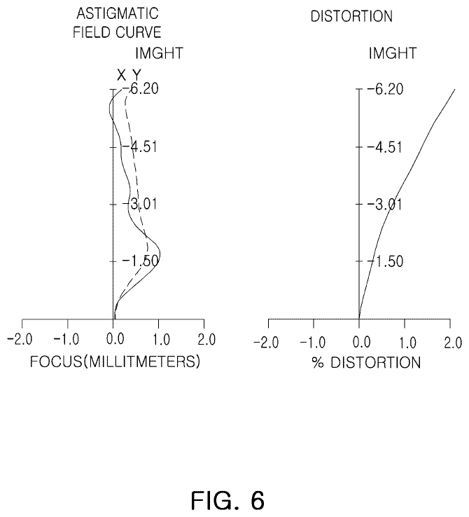

FIG. 6 illustrates an aberration curve of an imaging lens system according to the present disclosure.

Tables 7 to 9 illustrate lens characteristic values, aspherical values, and D1 and D2 values according to the position of the second lens group of the imaging lens system according to the present embodiment.

TABLE 7

| Surface | | Curvature | Thickness/ | Refractive | | Effective | Effective |
|---|---|---|---|---|---|---|---|
| No. | Component | Radius | Distance | Index | Abbe No. | Radius(Y) | Radius(X) |
| S1 | 1st Lens | 70.4458 | 5.0000 | 1.5164 | 64.1100 | 4.70 | 6.00 |
| S2 | Reflective | Infinity | 5.0000 | 1.5164 | 64.1100 | 7.07 | 6.00 |
| | surface | | | | | | |
| S3 | | 122.6500 | 2.0000 | | | 4.65 | 6.00 |
| S4 | 2nd Lens | 8.7891 | 2.8000 | 1.4370 | 95.0990 | 5.12 | 4.20 |
| S5 | | −117.1086 | 1.6645 | | | 4.90 | 4.20 |
| S6 | 3rd Lens | 21.3864 | 1.5938 | 1.6144 | 25.9363 | 4.42 | 4.20 |
| S7 | | 6.5832 | 0.5743 | | | 4.27 | 4.20 |
| S8 | 4th Lens | 12.0119 | 2.5000 | 1.5349 | 55.7354 | 4.07 | 4.07 |
| | (Stop) | | | | | | |
| S9 | | −9.4975 | D1 | | | 4.06 | 4.06 |
| S10 | 5th Lens | −4.5838 | 0.7383 | 1.5349 | 55.7354 | 3.50 | 3.50 |
| S11 | | −8.1019 | 0.1200 | | | 3.36 | 3.36 |
| S12 | 6th Lens | 24.4961 | 0.7200 | 1.6707 | 19.2383 | 3.30 | 3.30 |
| S13 | | 238.9591 | 0.1437 | | | 3.19 | 3.19 |
| S14 | 7th Lens | 7.6726 | 0.8506 | 1.5671 | 37.4035 | 3.19 | 3.19 |
| S15 | | 5.4425 | 2.6254 | | | 3.34 | 3.34 |
| S16 | 8th Lens | 28.4062 | 0.6297 | 1.5349 | 55.7354 | 3.62 | 3.62 |
| S17 | | 10.4971 | D2 | | | 4.00 | 4.00 |
| S18 | Filter | Infinity | 0.2100 | 1.5168 | 64.20 | 7.00 | 7.00 |
| S19 | | Infinity | 0.6249 | | | 7.00 | 7.00 |
| S20 | Imaging | Infinity | 0.0050 | | | | |
| | plane | | | | | | |

TABLE 8

| Surface | | | | | | | | |
|---|---|---|---|---|---|---|---|---|
| No. | S1 | S3 | S4 | S5 | S6 | S7 | S8 | S9 |
| K | −3.67E+01 | 0 | 0 | 0 | −8.11E+00 | −8.43E+00 | 3.46E−01 | 1.12E+00 |
| A | 8.56E−02 | 0 | 0 | 0 | 5.94E−01 | 1.54E−01 | 1.90E−01 | −1.65E−01 |
| B | 1.16E−01 | 0 | 0 | 0 | −2.29E−02 | 3.45E−02 | −3.24E−02 | −3.20E−02 |
| C | 1.30E−01 | 0 | 0 | 0 | 5.03E−04 | −1.23E−02 | −1.34E−02 | −7.64E−03 |
| D | 1.27E−01 | 0 | 0 | 0 | 7.91E−04 | 7.89E−03 | 4.96E−03 | 2.50E−05 |
| E | 1.15E−01 | 0 | 0 | 0 | −2.01E−05 | 6.39E−04 | 2.14E−03 | 3.99E−05 |
| F | 9.56E−02 | 0 | 0 | 0 | 4.02E−05 | −2.38E−04 | −3.16E−04 | 1.85E−04 |
| G | 7.30E−02 | 0 | 0 | 0 | −3.92E−05 | −3.39E−04 | −2.41E−04 | −9.30E−05 |
| H | 5.10E−02 | 0 | 0 | 0 | 2.66E−05 | 1.45E−04 | 1.16E−04 | 7.79E−05 |
| J | 3.23E−02 | 0 | 0 | 0 | 5.34E−06 | 1.71E−05 | 6.47E−05 | −3.41E−05 |
| L | 1.81E−02 | 0 | 0 | 0 | −6.44E−06 | −1.83E−05 | −3.66E−05 | 1.61E−05 |
| M | 8.86E−03 | 0 | 0 | 0 | 5.27E−06 | −1.05E−06 | 1.30E−05 | −1.61E−05 |
| N | 3.56E−03 | 0 | 0 | 0 | −3.10E−06 | 4.91E−06 | −2.95E−06 | 2.10E−05 |
| O | 1.09E−03 | 0 | 0 | 0 | −8.02E−06 | −4.20E−06 | 1.22E−06 | −1.12E−05 |
| P | 1.92E−04 | 0 | 0 | 0 | 3.12E−06 | 2.44E−06 | −4.45E−07 | 1.99E−06 |

| Surface | | | | | | | | |
|---|---|---|---|---|---|---|---|---|
| No. | S10 | S11 | S12 | S13 | S14 | S15 | S16 | S17 |
| K | −1.05E+01 | 1.03E−09 | −8.97E−02 | −3.65E−12 | 1.34E−09 | −9.87E+00 | −4.91E+01 | 2.11E+00 |
| A | −5.77E−01 | −1.26E+00 | −2.05E−01 | −1.59E−01 | 3.42E−01 | 2.55E−01 | 1.47E+00 | 1.85E+00 |
| B | 1.44E−01 | 2.84E−01 | −7.89E−02 | −9.93E−02 | 7.55E−02 | 4.66E−02 | −1.37E−01 | −1.85E−01 |
| C | −3.59E−02 | −5.06E−02 | 6.66E−03 | 1.64E−03 | −1.33E−02 | −2.19E−02 | −9.15E−03 | 1.93E−02 |
| D | 1.13E−02 | 1.71E−02 | −2.42E−03 | −4.71E−03 | 6.72E−03 | 2.92E−03 | −8.82E−03 | −7.10E−03 |
| E | −4.25E−03 | −5.92E−03 | 4.01E−03 | 7.27E−03 | 2.05E−03 | −2.21E−03 | −6.17E−04 | 6.56E−04 |
| F | 1.77E−03 | 3.73E−04 | −2.93E−03 | −1.97E−03 | −1.48E−04 | 7.51E−05 | 1.35E−04 | −5.97E−05 |
| G | −5.14E−04 | 3.58E−04 | 6.45E−04 | 8.18E−04 | 3.49E−04 | −4.77E−04 | 4.58E−05 | −9.81E−05 |
| H | 2.42E−04 | 2.80E−04 | −1.47E−04 | −4.45E−04 | −1.80E−04 | 2.00E−05 | −9.12E−06 | 6.14E−05 |
| J | −6.08E−05 | 4.80E−04 | 6.74E−04 | 3.49E−04 | 5.19E−05 | −8.29E−05 | −5.87E−06 | −5.11E−05 |
| L | 8.95E−07 | −4.87E−04 | −2.93E−04 | 2.66E−05 | 3.07E−05 | 1.47E−05 | −3.36E−05 | 1.79E−06 |
| M | 8.65E−06 | 1.01E−04 | 3.60E−05 | −3.38E−05 | −7.36E−05 | −2.91E−05 | 1.60E−05 | −1.63E−05 |
| N | −1.85E−05 | −5.43E−05 | −1.29E−05 | 4.31E−05 | 4.20E−05 | 8.67E−06 | −2.06E−06 | −6.51E−07 |
| O | 1.35E−05 | 4.53E−05 | 3.75E−06 | −3.14E−05 | −2.29E−05 | 3.88E−06 | 1.99E−05 | −4.28E−06 |
| P | −3.26E−06 | −9.66E−06 | −1.26E−06 | 7.84E−07 | 4.52E−06 | 3.13E−06 | −7.98E−06 | 5.91E−06 |

TABLE 9

| | Telephoto | wide |
|---|---|---|
| D1 | 1.200 | 3.600 |
| D2 | 5.000 | 2.600 |

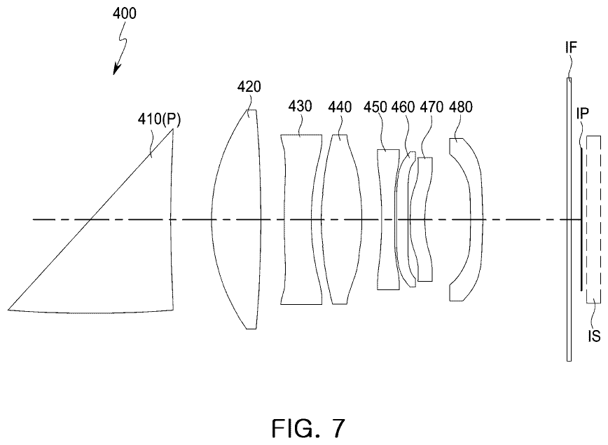

An imaging lens system according to a fourth embodiment will be described with reference to FIG. 7.

The imaging lens system 400 may include a plurality of lens groups. For example, the imaging lens system 400 may include a first lens group LG1 and a second lens group LG2 sequentially disposed from an object side. The first lens group LG1 and the second lens group LG2 may be comprised of a plurality of lenses. For example, the first lens group LG1 may be comprised of a first lens 410, a second lens 420, a third lens 430, and a fourth lens 440. The second lens group LG2 may be comprised of a fifth lens 450, a sixth lens 460, a seventh lens 470, and an eighth lens 480. However, the lenses configuring the first lens group LG1 and the second lens group LG2 are not limited to the above-described forms.

The imaging lens system 400 may be configured to capture and record a subject at infinite and extremely-close range distances. For example, the imaging lens system 400 may selectively capture and record subjects at infinite and extremely-close range distances by adjusting a displacement of the second lens group LG2 that enable to move in an optical axis direction. The imaging lens system 400 may include a reflective surface. For example, in the imaging lens system 400, the first lens 410 may be configured in a prism form including a reflective surface.

The optical characteristics of the lenses configuring the first lens group LG1 and the second lens group LG2 are described below.

The first lens 410 may have positive refractive power, and may have a convex object-side surface and a concave image-side surface. The second lens 420 may have positive refractive power, and may have a convex object-side surface and a convex image-side surface. The third lens 430 may have negative refractive power, and may have a convex object-side surface and a concave image-side surface. The fourth lens 440 may have positive refractive power, and may have a convex object-side surface and a convex image-side surface. The fifth lens 450 may have negative refractive power, and may have a concave object-side surface and a convex image-side surface. The sixth lens 460 may have positive refractive power, and may have a convex object-side surface and a concave image-side surface. The seventh lens 470 may have negative refractive power, and may have a convex object-side surface and a concave image-side surface. The eighth lens 480 may have negative refractive power, and may have a convex object-side surface and a concave image-side surface.

In the imaging lens system 400, some of lenses may be configured to have different effective radii in the first direction (X-direction) intersecting an optical axis and in the second direction (Y-direction) intersecting an optical axis. For example, the effective radius of the second lens 420 and the fourth lens 440 in the second direction may be greater than the effective radius in the first direction. As a specific example, the second lens 420 to fourth lens 440 may be lenses having a D-cut shape in which a portion of the lens is cut off.

The imaging lens system 400 may further include a filter IF and an imaging plane IP. The imaging plane IP may be formed on the image sensor IS, and the filter IF may be disposed between the eighth lens 480 and the imaging plane IP.

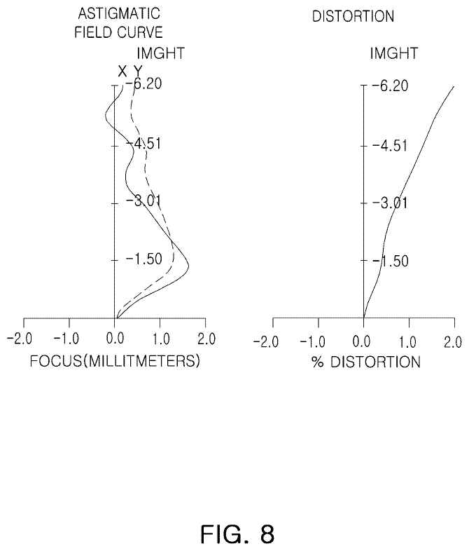

FIG. 8 illustrates an aberration curve of an imaging lens system according to the present disclosure.

Tables 10 to 12 illustrate lens characteristic values, aspherical values, and TTL, D1, and D2 values according to the position of the second lens group of the imaging lens system according to the present embodiment.

TABLE 10

| Surface | | Curvature | Thickness/ | Refractive | | Effective | Effective |
|---|---|---|---|---|---|---|---|
| No. | Component | Radius | Distance | Index | Abbe No. | Radius(Y) | Radius(X) |
| S1 | 1st Lens | 65.8591 | 5.2600 | 1.5164 | 64.1100 | 4.40 | 6.00 |
| S2 | Reflective | Infinity | 5.5000 | 1.5164 | 64.1100 | 6.50 | 6.00 |
| | surface | | | | | | |
| S3 | | 110.7628 | 2.0000 | | | 4.40 | 6.00 |
| S4 | 2nd Lens | 9.0066 | 2.8087 | 1.4370 | 95.0990 | 5.30 | 4.20 |
| S5 | | −94.5994 | 1.5487 | | | 5.08 | 4.20 |
| S6 | 3rd Lens | 23.1166 | 1.5980 | 1.6144 | 25.9363 | 4.55 | 4.20 |
| S7 | | 6.8609 | 0.5734 | | | 4.38 | 4.20 |
| S8 | 4th Lens | 12.7497 | 2.5000 | 1.5349 | 55.7354 | 4.33 | 4.20 |
| | (Stop) | | | | | | |
| S9 | | −9.1606 | D1 | | | 4.14 | 4.14 |
| S10 | 5th Lens | −4.5505 | 0.7321 | 1.5349 | 55.7354 | 3.50 | 3.50 |
| S11 | | −8.1618 | 0.1200 | | | 3.35 | 3.35 |
| S12 | 6th Lens | 23.3449 | 0.7200 | 1.6707 | 19.2383 | 3.30 | 3.30 |
| S13 | | 110.1188 | 0.1000 | | | 3.18 | 3.18 |
| S14 | 7th Lens | 6.8266 | 0.8704 | 1.5671 | 37.4035 | 3.20 | 3.20 |
| S15 | | 5.2051 | 2.6519 | | | 3.33 | 3.33 |
| S16 | 8th Lens | 43.6374 | 0.7073 | 1.5349 | 55.7354 | 3.56 | 3.56 |
| S17 | | 11.4961 | D2 | | | 4.00 | 4.00 |
| S18 | Filter | Infinity | | 1.5168 | 64.20 | 7.00 | 7.00 |
| S19 | | Infinity | | | | 7.00 | 7.00 |
| S20 | Imaging | Infinity | | | | | |
| | plane | | | | | | |

TABLE 11

| Surface | | | | | | | | |
|---|---|---|---|---|---|---|---|---|
| No. | S1 | S3 | S4 | S5 | S6 | S7 | S8 | S9 |
| K | −2.87E+01 | 0 | 0 | 0 | −7.62E+00 | −8.57E+00 | 2.77E−01 | 1.19E+00 |
| A | 3.85E−05 | 0 | 0 | 0 | 6.57E−01 | 1.85E−01 | 2.00E−01 | −1.82E−01 |
| B | −2.29E−03 | 0 | 0 | 0 | −2.39E−02 | 3.56E−02 | −3.37E−02 | −3.36E−02 |
| C | 6.72E−04 | 0 | 0 | 0 | 7.46E−04 | −1.33E−02 | −1.60E−02 | −8.79E−03 |
| D | −3.60E−04 | 0 | 0 | 0 | 6.82E−04 | 7.26E−03 | 3.54E−03 | −3.39E−04 |
| E | 1.88E−04 | 0 | 0 | 0 | −4.26E−05 | 2.70E−04 | 1.57E−03 | −2.41E−04 |
| F | −1.30E−04 | 0 | 0 | 0 | −1.84E−05 | −3.06E−04 | −5.43E−04 | 1.31E−04 |
| G | 7.63E−05 | 0 | 0 | 0 | 2.61E−05 | −7.07E−05 | 4.51E−05 | −9.56E−05 |
| H | −6.38E−05 | 0 | 0 | 0 | 1.57E−06 | 1.18E−04 | 1.16E−04 | 1.02E−04 |
| J | 4.07E−05 | 0 | 0 | 0 | 8.25E−06 | −1.85E−05 | 5.66E−05 | −2.87E−05 |
| L | −2.80E−05 | 0 | 0 | 0 | −3.21E−05 | −1.02E−04 | −1.43E−04 | 1.44E−05 |
| M | 1.82E−05 | 0 | 0 | 0 | 2.42E−05 | 4.03E−05 | 3.52E−05 | −2.86E−05 |
| N | −7.31E−06 | 0 | 0 | 0 | 8.33E−07 | 2.41E−05 | 9.25E−06 | 2.57E−05 |
| O | 1.32E−05 | 0 | 0 | 0 | −7.15E−06 | 2.98E−06 | 1.34E−05 | −1.18E−05 |
| P | −6.67E−06 | 0 | 0 | 0 | −4.57E−06 | −1.75E−05 | −1.61E−05 | 2.25E−06 |

| Surface | | | | | | | | |
|---|---|---|---|---|---|---|---|---|
| No. | S10 | S11 | S12 | S13 | S14 | S15 | S16 | S17 |
| K | −1.06E+01 | 1.03E−09 | −8.97E−02 | −3.65E−12 | 1.34E−09 | −9.51E+00 | −7.86E+01 | 2.87E+00 |
| A | −5.75E−01 | −1.25E+00 | −1.96E−01 | −1.64E−01 | 3.48E−01 | 2.49E−01 | 1.41E+00 | 1.77E+00 |
| B | 1.47E−01 | 2.82E−01 | −7.61E−02 | −9.49E−02 | 7.31E−02 | 4.98E−02 | −1.19E−01 | −1.80E−01 |
| C | −3.71E−02 | −5.27E−02 | 7.57E−03 | 1.20E−03 | −1.39E−02 | −1.87E−02 | −4.34E−03 | 2.18E−02 |
| D | 1.17E−02 | 1.67E−02 | −4.31E−03 | −6.68E−03 | 5.26E−03 | 2.51E−03 | −7.60E−03 | −6.93E−03 |
| E | −4.40E−03 | −5.69E−03 | 3.72E−03 | 5.42E−03 | 3.31E−04 | −2.13E−03 | −6.34E−04 | 1.02E−03 |
| F | 1.65E−03 | 4.91E−04 | −2.25E−03 | −1.17E−03 | 5.76E−04 | 4.32E−04 | 9.28E−06 | −1.60E−04 |
| G | −4.63E−04 | 3.68E−04 | 6.49E−04 | 3.73E−04 | −2.06E−04 | −5.24E−04 | 6.60E−05 | 4.24E−06 |
| H | 1.52E−04 | −6.56E−05 | −2.63E−04 | −2.05E−04 | 9.72E−05 | 1.09E−04 | −2.50E−05 | 4.59E−06 |
| J | −1.94E−05 | 4.86E−04 | 5.88E−04 | 2.41E−04 | −2.01E−05 | −8.48E−05 | 1.81E−05 | 9.47E−07 |
| L | −9.73E−06 | −4.15E−04 | −2.90E−04 | −1.12E−05 | 4.45E−05 | 1.66E−05 | −4.27E−05 | −2.61E−05 |
| M | 1.57E−05 | 1.01E−04 | 4.81E−05 | −2.52E−05 | −5.94E−05 | −2.71E−05 | 1.57E−05 | 8.47E−06 |
| N | −1.15E−05 | −4.72E−05 | −3.34E−05 | 6.32E−06 | 1.62E−05 | 4.98E−06 | −2.20E−07 | −6.52E−06 |
| O | 6.25E−07 | 3.78E−05 | 6.25E−06 | −2.70E−05 | −2.83E−05 | 4.22E−07 | 1.57E−05 | 1.61E−07 |
| P | 9.67E−07 | −8.49E−06 | 2.41E−06 | 7.85E−07 | 2.99E−06 | 5.59E−06 | −6.56E−06 | 2.38E−06 |

TABLE 12

| | Telephoto | wide |
|---|---|---|
| D1 | 1.200 | 3.600 |
| D2 | 5.000 | 2.600 |

Tables 13 to 17 illustrate the optical characteristic values and conditional expression values of the imaging lens system according to the first to fourth embodiments.

TABLE 13

| | 1^{st} | 2^{nd} | 3^{rd} | 4^{th} |
|---|---|---|---|---|
| | Embodiment | Embodiment | Embodiment | Embodiment |
| TTL | 34.000 | 33.401 | 34.000 | 34.760 |
| f | 22.474 | 22.474 | 22.474 | 22.474 |
| f number | 2.157 | 2.175 | 2.145 | 2.107 |
| ImgHT | 5.720 | 5.720 | 5.720 | 5.720 |
| f | 22.474 | 22.474 | 22.474 | 22.474 |
| f1 | 250.709 | 200.571 | 300.875 | 290.853 |
| f2 | 18.618 | 20.881 | 18.836 | 18.975 |
| f3 | −15.061 | −15.955 | −16.140 | −16.496 |
| f4 | 10.124 | 10.064 | 10.335 | 10.379 |
| f5 | −19.611 | −16.435 | −21.293 | −20.691 |
| f6 | 32.494 | 55.369 | 40.640 | 44.024 |
| f7 | −33.323 | −363.368 | −38.305 | −47.958 |
| f8 | −33.252 | −33.555 | −31.516 | −29.407 |
| fG1 | 13.313 | 13.195 | 13.171 | 13.159 |
| fG2 | −11.344 | −11.852 | −11.104 | −11.038 |

TABLE 14

| Conditional | 1^{st} | 2^{nd} | 3^{rd} | 4^{th} |
|---|---|---|---|---|
| Expression | Embodiment | Embodiment | Embodiment | Embodiment |
| f1/f | 11.1553 | 8.9244 | 13.3874 | 12.9415 |
| fG2/f8 | 0.3411 | 0.3532 | 0.3523 | 0.3754 |
| TTL/f | 1.5128 | 1.4862 | 1.5128 | 1.5466 |
| PH/ERmax | 0.9766 | 0.8967 | 0.9766 | 1.0151 |
| EPD/TTL | 0.3064 | 0.3094 | 0.3082 | 0.3069 |

TABLE 15

| Conditional | 1^{st} | 2^{nd} | 3^{rd} | 4^{th} |
|---|---|---|---|---|
| Expression | Embodiment | Embodiment | Embodiment | Embodiment |
| f1/f | 11.1553 | 8.9244 | 13.3874 | 12.9415 |
| f2/f | 0.8284 | 0.9291 | 0.8381 | 0.8443 |
| f3/f | −0.6701 | −0.7099 | −0.7182 | −0.7340 |
| f4/f | 0.4505 | 0.4478 | 0.4599 | 0.4618 |
| f5/f | −0.8726 | −0.7313 | −0.9474 | −0.9206 |
| f6/f | 1.4458 | 2.4636 | 1.8083 | 1.9589 |
| f7/f | −1.4827 | −16.1681 | −1.7044 | −2.1339 |
| f8/f | −1.4795 | −1.4930 | −1.4023 | −1.3085 |

TABLE 16

| Conditional | 1^{st} | 2^{nd} | 3^{rd} | 4^{th} |
|---|---|---|---|---|
| Expression | Embodiment | Embodiment | Embodiment | Embodiment |
| (f2 + f3)/ | −0.3749 | −0.7731 | −0.2460 | −0.2404 |
| (f4 + f5) | | | | |
| f1/f8 | −7.5397 | −5.9773 | −9.5467 | −9.8905 |
| f1/ | −10.2132 | −8.9837 | −11.1030 | −10.8497 |
| (f3 + f4 + f5) | | | | |

TABLE 17

| Conditional | 1^{st} | 2^{nd} | 3^{rd} | 4^{th} |
|---|---|---|---|---|
| Expression | Embodiment | Embodiment | Embodiment | Embodiment |
| f1/TTL | 7.3738 | 6.0049 | 8.8493 | 8.3675 |
| f1/R1 | 2.7901 | 2.8188 | 4.2710 | 4.4163 |
| f1/R2 | 0.8873 | 0.9239 | 2.4531 | 2.6259 |
| f1/(R1 + R2) | 0.6732 | 0.6958 | 1.5582 | 1.6468 |
| f1/T1 | 25.0709 | 21.3373 | 30.0875 | 27.0310 |

The imaging lens system according to the present embodiment may have a unique numerical range for focal lengths of the first to eighth lenses. For example, a focal length of the first lens may be determined to be within a range of 200 mm to 320 mm, a focal length of the second lens may be determined to be within a range of 16 mm to 24 mm, a focal length of the third lens may be determined to be within a range of-18.0 mm to-14.0 mm, a focal length of the fourth lens may be determined to be within a range of 8.0 mm to 12.0 mm, a focal length of the fifth lens may be determined to be within a range of-24.0 mm to-12.0 mm, a focal length of the sixth lens may be determined to be within a range of 30 mm to 60 mm, a focal length of the seventh lens may be determined to be within a range of-400 mm to-30 mm, and a focal length of the eighth lens may be determined to be within a range of-40.0 mm to-20 mm.

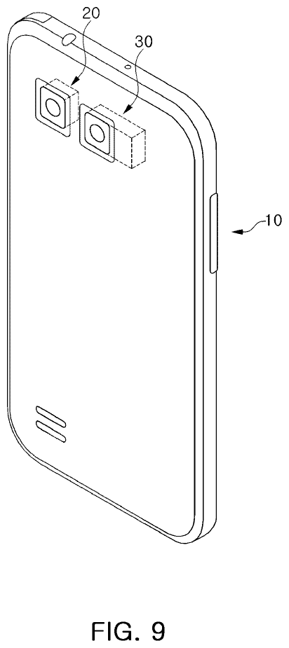

An electronic device according to an embodiment of the present disclosure is described with reference to FIG. 9.

An electronic device 10 according to an embodiment of the present disclosure may include a camera module. For example, the electronic device 10 may be a portable terminal including camera modules 20 and 30. However, the form of the electronic device 10 may not be limited to a portable terminal. For example, the electronic device 10 may include any portable electronic device such as a laptop, a tablet PC or the like. At least one of the camera modules 20 and 30 may include one of the imaging lens systems 100, 200, 300, and 400 according to the first to fourth embodiments.

The present disclosure may provide an imaging lens system capable of capturing high-resolution images of a subject located at an infinite and close distance.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens, a second lens, a third lens, a fourth lens, a fifth lens, a sixth lens, a seventh lens, and an eighth lens sequentially disposed from an object side,
wherein the first lens includes a reflective surface, and the imaging lens system satisfies 0<f1/f<20,
where f is a focal length of the imaging lens system and f1 is a focal length of the first lens.

2. The imaging lens system of claim 1, wherein the first lens has a convex object-side surface.

3. The imaging lens system of claim 1, wherein the second lens has a convex object-side surface.

4. The imaging lens system of claim 1, wherein the third lens has a convex object-side surface.

5. The imaging lens system of claim 1, wherein the fourth lens has a convex object-side surface.

6. The imaging lens system of claim 1, wherein the fifth lens has a concave object-side surface.

7. The imaging lens system of claim 1, wherein the sixth lens has a convex object-side surface.

8. The imaging lens system of claim 1, wherein the seventh lens has a convex object-side surface.

9. The imaging lens system of claim 1, wherein the first lens is a prism.

10. An electronic device comprising the imaging lens system of claim 1.

11. An imaging lens system comprising:
a first lens, a second lens, a third lens, a fourth lens, a fifth lens, a sixth lens, a seventh lens having negative refractive power, and an eighth lens having a convex object-side surface sequentially disposed from an object side,
wherein the imaging lens system satisfies 5.0<f1/TTL<10.0,
where TTL is a distance from an object side of the first lens to an imaging plane and f1 is a focal length of the first lens.

12. The imaging lens system of claim 11, wherein the first lens has a convex object-side surface.

13. The imaging lens system of claim 11, wherein the second lens has a convex object-side surface.

14. The imaging lens system of claim 11, wherein the third lens has a convex object-side surface.

15. The imaging lens system of claim 11, wherein the fourth lens has a convex object-side surface.

16. The imaging lens system of claim 11, wherein the fifth lens has a concave object-side surface.

17. The imaging lens system of claim 11, wherein the sixth lens has a convex object-side surface.

18. The imaging lens system of claim 11, wherein the seventh lens has a convex object-side surface.

19. An electronic device comprising the imaging lens system of claim 11.
